(19) United States
(12) Patent Application Publication
(10) Pub. No.: US 2022/0334253 A1
(43) Pub. Date: Oct. 20, 2022

(54) STROBE BASED CONFIGURABLE 3D FIELD OF VIEW LIDAR SYSTEM

(71) Applicants: Sense Photonics, Inc., Durham, NC (US); The University Court of The University of Edinburgh, Edinburgh (GB)

(72) Inventors: Tarek Al Abbas, Edinburgh (GB); Neil Calder, Edinburgh (GB); Robert Henderson, Edinburgh (GB); Hod Finkelstein, Berkeley, CA (US)

(21) Appl. No.: 17/765,420

(22) PCT Filed: Sep. 30, 2020
(86) PCT No.: PCT/US2020/053444

§ 371 Date: Mar. 30, 2022

Related U.S. Application Data
(60) Provisional application No. 62/908,801, filed on Oct. 1, 2019.

(51) Int. Cl. G01S 17/18; G01S 17/89; G01S 7/4863

(52) U.S. Cl. CPC G01S 17/18; G01S 17/89; G01S 7/4863

(57) ABSTRACT

A Light Detection and Ranging (LIDAR) system includes an emitter array comprising a plurality of emitter units operable to emit optical signals, a detector array comprising a plurality of detector pixels operable to detect light for respective strobe windows between pulses of the optical signals, and one or more control circuits. The control circuit(s) are configured to selectively operate different subsets of the emitter units and/or different subsets of the detector pixels such that a field of illumination of the emitter units and/or a field of view of the detector pixels is varied based on the respective strobe windows. Related devices and methods of operation are also discussed.

### CLAIM OF PRIORITY

This application claims priority under 35 U.S.C. 119 from U.S. Provisional Patent Application No. 62/908,801 entitled “Strobe Based Configurable 3D Field of View LIDAR System,” filed Oct. 1, 2019, with the United States Patent and Trademark Office, the disclosure of which is incorporated by reference herein in its entirety.

### FIELD

The present invention relates generally to imaging, and more specifically to Light Detection And Ranging (LIDAR)-based imaging.

### BACKGROUND

Flash-type LIDAR (also referred to herein as lidar), which can use a pulsed light emitting array to emit light for short durations over a relatively large area to acquire images, may allow for solid-state imaging of a large field of view or scene.

However, to illuminate such a large field of view (which may include long range and/or low-reflectance targets and in bright ambient light conditions) and still receive a recognizable return or reflected optical signal therefrom (also referred to herein as an echo signal or echo), higher optical emission power may be required. Moreover, higher emission power (and thus higher power consumption) may be required in some applications due to the relatively high background noise levels from ambient and/or other non-LIDAR emitter light sources (also referred to therein as a noise floor).

Power consumption in lidar systems can be particularly problematic in some applications, e.g., unmanned aerial vehicle (UAV), automotive, and industrial robotics. For example, in automotive applications, the increased emission power requirements must be met by the power supply of the automobile, which may add a considerable load for automobile manufacturers. Also, heat generated from the higher emission power may alter the optical performance of the light emitting array and/or may negatively affect reliability.

### SUMMARY

Some embodiments described herein provide methods, systems, and devices including electronic circuits to address the above and other problems by providing a lidar system including one or more emitter elements (including one or more semiconductor lasers, such as surface- or edge-emitting laser diodes; generally referred to herein as emitters), one or more light detector pixels (including one or more semiconductor photodetectors, such as photodiodes, including avalanche photodiodes and single-photon avalanche detectors; generally referred to herein as detectors), and a control circuit that is configured to selectively operate subsets of the emitter elements and/or detector pixels (including respective emitters and/or detectors thereof) to provide a 3D time of flight (ToF) flash lidar system with a configurable field of illumination and/or field of view for subranges of a distance range that can be imaged by the lidar system (also referred to as an imaging distance range).

In some embodiments, a lidar system including a receiver (e.g., a detector array) and a transmitter (e.g., an emitter array) operates based on strobe signals that define respective strobe windows (each corresponding to a respective subrange of the distance range), whereby the field of illumination of the emitter element(s) and/or the field of view of the detector pixel(s) can be programmed or varied on a strobe-by-strobe basis for a more efficient and lower power system performance, and/or in response to objects in the field of view (FoV) (such as to reduce multipath reflections from tunnel walls and ceiling).

According to some embodiments of the present invention, a Light Detection and Ranging (LIDAR) system includes an emitter array comprising a plurality of emitter units operable to emit optical signals, responsive to respective emitter control signals; a detector array comprising a plurality of detector pixels operable to be activated and deactivated to detect light for respective strobe windows between pulses of the optical signals and at respective delays that differ with respect to the pulses, responsive to respective strobe signals; and one or more control circuits. The control circuit(s) are configured to output the respective emitter control signals to selectively operate different subsets of the emitter units and/or to output the respective strobe signals to selectively operate different subsets of the detector pixels such that a field of illumination of the emitter units and/or a field of view of the detector pixels is varied based on the respective strobe windows.

In some embodiments, the respective strobe windows may correspond to respective sub-ranges of a distance range. For example, the respective strobe windows may include first and second strobe windows corresponding to different first and second sub-ranges of a distance range, respectively.

In some embodiments, the one or more control circuits may include an emitter control circuit configured to operate a first subset of the emitter units to provide a first field of illumination during the first strobe window, and to operate a second subset of the emitter units to provide a second field of illumination, different than the first field of illumination, during the second strobe window.

In some embodiments, the one or more control circuits may include a detector control circuit configured to operate a first subset of the detector pixels to provide a first field of view during the first strobe window, and to operate a second subset of the detector pixels to provide a second field of view, different than the first field of view, during the second strobe window.

In some embodiments, the detector control circuit may be configured to operate the second subset of the detector pixels with a greater detection sensitivity level than the first subset of the detector pixels.

In some embodiments, each of the detector pixels may include a plurality of detectors, and the detector control circuit may be configured to generate respective strobe signals that activate a first subset of the detectors for the first strobe window, and activate a second subset of the detectors, larger than the first subset of the detectors, for the second strobe window.

In some embodiments, the second field of illumination may include a greater emission power level than the first field of illumination.

In some embodiments, the emitter control circuit may be configured to generate respective emitter control signals comprising a first non-zero peak current to activate the first subset of the emitters for the first strobe window, and comprising a second peak current, greater than the first non-zero peak current, to activate the second subset of the emitters for the second strobe window.

In some embodiments, the first strobe window may corresponds to closer distance sub-ranges of the distance range than the second strobe window, and the first field of illumination and/or the first field of view may be wider than the second field of illumination and/or the second field of view.

In some embodiments, the first subset of the emitter units may include one or more of the emitter units that are positioned at a peripheral region of the emitter array, and the second subset of the emitter units may include one or more of the emitter units that are positioned at a central region of the emitter array.

In some embodiments, the first subset of the emitter units may include a first string of the emitter units that are electrically connected in series, and the second subset of the emitter units may include a second string of the emitter units that are electrically connected in series.

In some embodiments, the first subset of the detector pixels may include one or more of the detector pixels that are positioned at a peripheral region of the detector array, and the second subset of the detector pixels may include one or more of the detector pixels that are positioned at a central region of the detector array.

In some embodiments, the different subsets of the emitter units may be operable to provide the field of illumination without one or more lens elements. For example, the emitter array may include the emitter units on a curved and/or flexible substrate, where a curvature of the substrate is configured to provide the field of illumination without the one or more lens elements.

In some embodiments, the respective strobe windows may correspond to respective acquisition subframes of the detector pixels. Each acquisition subframe may include data collected for a respective distance sub-range of a distance range. An image frame may include the respective acquisition subframes for each of the distance sub-ranges of the distance range.

In some embodiments, the image frame may be a current image frame, and the one or more control circuits may be configured to provide the field of illumination of the emitter units and/or the field of view of the detector pixels that varies for the respective sub-ranges of the distance range in the current image frame based on one or more features of the field of view indicated by detection signals received from the detector pixels in a preceding image frame before the current image frame.

In some embodiments, in the preceding image frame, the one or more control circuits may be configured to provide the field of illumination of the emitter units and/or the field of view of the detector pixels that is static for the respective sub-ranges of the distance range.

According to some embodiments of the present invention, a Light Detection and Ranging (LIDAR) system includes at least one control circuit configured to output respective emitter control signals to operate emitter units of an emitter array and/or respective strobe signals to operate detector pixels of a detector array such that a field of illumination of the emitter units and/or a field of view of the detector pixels varies for respective sub-ranges of a distance range imaged by the LIDAR system.

In some embodiments, the detector pixels may be operable to detect light for respective strobe windows between pulses of the optical signals responsive to the respective strobe signals, where the respective strobe windows may correspond to the respective sub-ranges of the distance range.

In some embodiments, the respective strobe signals may operate a first subset of the detector pixels to detect the light over a first field of view during a first strobe window, and may operate a second subset of the detector pixels to detect light over a second field of view, different than the first field of view, during a second strobe window.

In some embodiments, the respective strobe signals may operate the second subset of the detector pixels with a greater detection sensitivity level than the first subset of the detector pixels.

In some embodiments, each of the detector pixels may include a plurality of detectors. The respective strobe signals may activate a first subset of the detectors for the first strobe window, and may activate a second subset of the detectors, larger than the first subset of the detectors, for the second strobe window.

In some embodiments, the respective emitter control signals may operate a first subset of the emitter units to provide a first field of illumination during a first strobe window, and may operate a second subset of the emitter units to provide a second field of illumination, different than the first field of illumination, during a second strobe window.

In some embodiments, the second field of illumination may include a greater emission power level than the first field of illumination.

In some embodiments, the respective emitter control signals may include a first non-zero peak current to activate the first subset of the emitters for the first strobe window, and may include a second peak current, greater than the first non-zero peak current, to activate the second subset of the emitters for the second strobe window.

According to some embodiments of the present invention, a method of operating a Light Detection and Ranging (LIDAR) system includes generating respective emitter control signals to operate different subsets of emitter units of an emitter array to emit optical signals and/or generating respective strobe signals to operate different subsets of detector pixels of a detector array to detect light, such that a field of illumination of the emitter units and/or a field of view of the detector pixels varies for respective sub-ranges of a distance range imaged by the LIDAR system.

In some embodiments, the detector pixels may be operable to detect light for respective strobe windows between pulses of the optical signals responsive to the respective strobe signals. The respective strobe windows may include first and second strobe windows corresponding to different first and second sub-ranges of a distance range, respectively.

In some embodiments, the respective emitter control signals may operate a first subset of the emitter units to provide a first field of illumination during the first strobe window, and may operate a second subset of the emitter units to provide a second field of illumination, different than the first field of illumination, during the second strobe window.

In some embodiments, the respective emitter control signals may operate the second subset of the emitter units with a greater power level than the first subset of the emitter units.

In some embodiments, the respective strobe signals may operate a first subset of the detector pixels to provide a first field of view during the first strobe window, and may operate a second subset of the detector pixels to provide a second field of view, different than the first field of view, during the second strobe window.

In some embodiments, the respective strobe signals may operate the second subset of the detector pixels with a greater detection sensitivity level than the first subset of the detector pixels.

In some embodiments, the LIDAR system may be configured to be coupled to an autonomous vehicle such that the emitter and detector arrays are oriented relative to an intended direction of travel of the autonomous vehicle.

Other devices, apparatus, and/or methods according to some embodiments will become apparent to one with skill in the art upon review of the following drawings and detailed description. It is intended that all such additional embodiments, in addition to any and all combinations of the above embodiments, be included within this description, be within the scope of the invention, and be protected by the accompanying claims.

### BRIEF DESCRIPTION OF THE DRAWINGS

FIG. 1 is a schematic block diagram illustrating an example lidar system or circuit that is configured to provide a field of view that varies as a function of the distance sub-ranges being imaged by the lidar system in accordance with some embodiments of the present invention.

FIG. 2 is a schematic block diagram illustrating an example lidar control circuit in accordance with some embodiments of the present invention.

FIGS. 3A, 3B, and 3C are schematic diagrams illustrating dynamically varying the field of view of a lidar system as a function of the distance sub-ranges being imaged in accordance with embodiments of the present invention.

FIGS. 4, 5, 6, 7A, 7B, 8, 9A, 9B, 9C, 10A, 10B, and 10C are schematic diagrams illustrating example strobe window timings and corresponding operations of an emitter array, a detector array, and related control circuitry to provide a field of view that varies as a function of the distance sub-ranges being imaged by the lidar system in accordance with some embodiments of the present invention.

FIG. 11 is a graph illustrating the timings of subframes in a full image acquisition frame in accordance with some embodiments of the present invention.

FIG. 12 is a graph illustrating variations in operating power and/or operating density of subsets of emitters over the image acquisition frame in accordance with some embodiments of the present invention.

FIG. 13 is a graph illustrating operation of different subsets of emitters for different distance sub-ranges in accordance with some embodiments of the present invention.

FIG. 14 is a graph illustrating operation of different subsets of detectors for different distance sub-ranges in accordance with some embodiments of the present invention.

### DETAILED DESCRIPTION OF EMBODIMENTS

A lidar system may include an array of emitters and an array of detectors, or a system having a single emitter and an array of detectors, or a system having an array of emitters and a single detector. As described herein, one or more emitters may define an emitter unit, and one or more detectors may define a detector pixel. A flash lidar system may acquire images by emitting light from an array of emitters, or a subset of the array, for short durations (pulses) over a field of view (FoV) or scene, and detecting the echo signals reflected from one or more targets in the FoV at one or more detectors. Subregions of the array of emitter elements are configured to direct light to (and subregions of the array of detector elements are configured to receive light from) respective subregions within the FoV, which are also referred to herein as regions of interest (ROIs). A non-flash or scanning lidar system may generate image frames by scanning light emission over a field of view or scene, for example, using a point scan or line scan to emit the necessary power per point and sequentially scan to reconstruct the full FoV. A non-range-strobing lidar illuminates the whole range of interest and collects echoes from the whole range of interest. An indirect time-of-flight (iToF) lidar measures range by detecting a phase offset of an echo signal with reference to an emitted signal, whereas a direct time-of-flight (dToF) lidar measures range by detecting the time from emission of a pulse of light to detection of an echo signal by a receiver.

The field of view of a lidar system may be referred to herein as including the field of illumination of light or optical signals output from the emitters and/or the field of view or field of detection over which light is collected by the receiver or detectors. In some embodiments, the field of view of the lidar system may include the intersection of the field of illumination of the emitters, the field of view of the detectors, and the temporal ‘strobe’ windows during which collected light can be detected with reference to the emitted optical signals.

Strobing as used herein may refer to the generation of detector control signals (also referred to herein as strobe signals or ‘strobes’) to control the timing and/or duration of activation (also referred to herein as detection windows or strobe windows) of one or more detectors of the lidar system. In some embodiments, the strobe windows may correspond to sub-ranges of the imaging distance range of a dToF lidar system, thus capturing reflected signal photons corresponding to specific distance sub-ranges at each window) to limit the number of ambient photons acquired in each emitter cycle. The reflected signal photons may be distinguished from ambient photons using a correlator circuit configured to output respective correlation signals representing detection of one or more of the photons whose respective time of arrival is within a predetermined correlation time relative to at least one other of the photons, as described for example in United States Patent Application Publication No. 2019/0250257 to Finkelstein et al, the disclosure of which is incorporated by reference herein. An emitter cycle (e.g., a laser cycle) refers to the time between emitter pulses. In some embodiments, the emitter cycle time is set as or otherwise based on the time required for an emitted pulse of light to travel round trip to the farthest allowed target and back, that is, based on a desired distance range. To cover targets within a desired distance range of about 400 meters, a laser in some embodiments may operate at a frequency of at most 375 kHz (i.e., emitting a laser pulse about every 2.66 microseconds or more). Strobing may be advantageous in terms of area or ‘real estate’ on a substrate (e.g., silicon) because the amount of memory needed in a pixel (in terms of bits per pixel, or bits/pixel) may be proportional to a ratio of the imaging distance range and the range resolution. For example, to provide 10 centimeter (cm) resolution over a 400 meter (m) imaging distance range may require (400 m/0.1 m)=4000 bins×10 bits/bin=40,000 bits/pixel; to provide 10 cm resolution over a 10 meter imaging distance range may require 10/0.1=100 bins×10 bits/bin=1,000 bits/pixel.

In some lidar implementations, different imaging distance ranges may be achieved by using different emitter modules. For example, an emitter module of a lidar system configured to image targets up to a desired distance range may be designed to emit four times the power per solid angle as compared to an emitter module configured to image up to half of the desired distance range, and/or may be configured to emit pulses at half the repetition rate in order to prevent range ambiguity. Such an implementation may also include hardwiring of emitter modules, resulting in less flexible system configurations and a static architecture which cannot respond to conditions on the fly/in real-time. For example, when driving in a tunnel, it may be desirable to reduce the long range field of view at larger angles in order to reduce multipath reflections from the walls and the ceiling of the tunnel, but the field of view should return to its nominal ranges once exiting the tunnel.

Also, some lidar systems may use strobes (also referred to as time gates) and may count the number of photons that arrive within a time gate, but may not directly measure their precise time of flight. Some range-strobing dToF lidar systems can measure time of flight and maintain a FoV (e.g., 30 degrees horizontal by 30 degrees vertical) for all strobe gates.

Some embodiments of the present invention arise from recognition that, in lidar systems, the power that may be required to image a target scales with the square of the distance range of the target. At the same time, many applications of lidar systems may require a wide field of view for closer ranges, but can provide acceptable performance with a smaller field of view for long ranges, particularly if the smaller field of view may result in reduced power consumption. Thus, some embodiments of the present invention provide lidar systems where the FoV is configured to dynamically vary 43.3 with distance sub-ranges (or the respective strobe windows corresponding to the distance sub-ranges) of the imaging distance. For example, some embodiments may operate an emitter array and/or a detector array to provide a wide FoV in short ranges and narrow FoV in long ranges, in some embodiments in combination with various detection modalities as described herein.

In particular, respective emitter control signals may be generated to operate one or more emitter units of an emitter array to emit optical signals that illuminate different portions or ROIs of a field of view for different image acquisition subframes of the detector array. Additionally or alternatively, respective strobe signals may be generated to operate one or more detector pixels of the detector array to detect light over different ROIs of the field of view for the different image acquisition subframes. Each image acquisition subframe collects data for a different strobe window (and thus, the respective distance sub-ranges corresponding to the different strobe windows). The respective sub-ranges are portions of a distance range that is based on or defined by a time between pulses of the optical signals. In some embodiments, the emitters and/or detectors may be operated to vary the FoV of the lidar system based on one or more targets, features, or other characteristics of a scene imaged thereby, for example, based on information determined from detection signals corresponding to a preceding image acquisition frame.

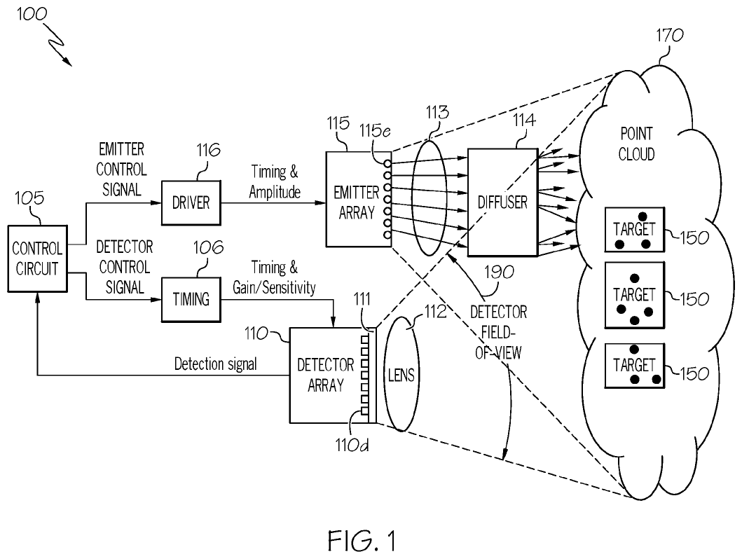

An example of a LIDAR system or circuit 100 in accordance with embodiments of the present disclosure is shown in FIG. 1. The system 100 includes at least one control circuit 105, a timing circuit 106, an emitter array 115 including a plurality of emitters 115e, and a detector array 110 including a plurality of detectors 110d. The detectors 110d include time-of-flight sensors (for example, an array of single-photon detectors, such as Geiger-mode Avalanche Diodes (e.g., SPADs), or sub-Geiger-mode avalanche diodes (e.g., avalanche photodiodes (APDs)). A SPAD (single-photon avalanche detector) is based on a semiconductor junction (e.g., a p-n junction) that may detect incident photons when biased beyond its breakdown region, for example, by or in response to a strobe signal having a desired pulse width (also referred to herein as “strobing”). The high reverse bias voltage generates a sufficient magnitude of electric field such that a single charge carrier introduced into the depletion layer of the device can cause a self-sustaining avalanche via impact ionization. Once the avalanche occurs, the SPAD may be unable to detect additional photons (e.g., the SPAD may experience a “dead” time). The avalanche is quenched by a quench circuit, either actively (e.g., by reducing the bias voltage) or passively (e.g., by using the voltage drop across a serially connected resistor), to allow the device to be “reset” to detect further photons. The initiating charge carrier can be photo-electrically generated by means of a single incident photon striking the high field region. It is this feature which gives rise to the name “Single Photon Avalanche Diode.” This single photon detection mode of operation is often referred to as “Geiger Mode.”

One or more of the emitter elements 115e of the emitter array 115 may define emitter units that respectively emit a radiation pulse or continuous wave signal (for example, through a diffuser or optical filter 114) at a time and repetition rate controlled by a timing generator or driver circuit 116. In particular embodiments, the emitters 115e may be pulsed light sources, such as LEDs or lasers (such as vertical cavity surface emitting lasers (VCSELs) and/or edge-emitting lasers). Radiation is reflected back from a target 150, is collected by collection optics 112, and is sensed by detector pixels defined by one or more detector elements 110d of the detector array 110. The control circuit 105 implements a processing circuit that measures the time of flight of the illumination pulse over the journey from emitter array 115 to target 150 and back to the detectors 110d of the detector array 110, using direct or indirect ToF measurement techniques.

In some embodiments, an emitter module or circuit 115 may include an array of emitter elements 115e (e.g., VCSELs), a corresponding array of optical elements 113, 114 coupled to one or more of the emitter elements (e.g., lens(es) 113 (such as microlenses) and/or diffusers 114), driver electronics 116, and (optionally) a safety mechanism. The optical elements 113, 114 can be configured to provide a sufficiently low beam divergence of the light output from the emitter elements 115e so as to ensure that fields of illumination of either individual or groups of emitter elements 115e do not significantly overlap, and yet provide a sufficiently large beam divergence of the light output from the emitter elements 115e to provide eye safety to observers. In some embodiments, one or more of the optical elements 113, 114 may be omitted. For example, the emitter array 115 may be implemented on a curved or flexible substrate, such that a desired field of illumination may be achieved based on the curvature of the emitter array 115 without the use of the lens(es) 113. More particularly, a desired horizontal field of illumination may be provided by the curvature of the emitter array 115 without the lens(es) 113, while a desired vertical field of illumination may be provided by the diffuser(s) 114, or vice versa. Conversely, the desired horizontal and/or vertical fields of illumination may be achieved using the lens(es) 113 without the diffuser(s) 114.

The driver electronics 116 may each correspond to one or more emitter elements, and may each be operated responsive to timing control signals with reference to a master clock and/or power control signals that control the peak power of the light output by the emitter elements 115e. In some embodiments, each of the emitter elements 115e in the emitter array 115 is connected to and controlled by a respective driver circuit 116. In other embodiments, respective groups of emitter elements 115e in the emitter array 115 (e.g., emitter elements 115e in spatial proximity to each other, such as serially connected (i.e., anode-to-cathode) strings of emitter elements 115e), may be connected to a same driver circuit 116. The driver circuit or circuitry 116 may include one or more driver transistors configured to control the pulse repetition rate, timing and amplitude of the optical emission signals that are output from the emitters 115e.

The safety mechanism may be configured to control one or more emitters 115e to immediately reduce or power down the emission power if an object is detected in the field of illumination within a pre-determined distance from the emitter module or circuit 115. For example, the safety mechanism may include a range finder, the control circuit 105 may electronically implement the functionality of the safety mechanism, or the lidar system itself may otherwise have a mechanism to detect an object within the pre-determined distance of the emitter module 115 and power down the emission power of the emitter array 115 sufficiently quickly in response. In some embodiments, the pre-determined distance range may be about 1 meter (m) or less.

The emission of optical signals from multiple emitters 115e (e.g., to illuminate the whole range of interest, over one or more detection windows) provides a single image frame for the flash LIDAR system 100. The maximum optical power output of the emitters 115e may be selected to generate a signal-to-noise ratio of the echo signal from the farthest, least reflective target at the brightest background illumination conditions that can be detected in accordance with embodiments described herein. An optional filter to control the emitted wavelengths of light and diffuser 114 to increase a field of illumination of the emitter array 115 are illustrated by way of example.

Light emission output from one or more of the emitters 115e impinges on and is reflected by one or more targets 150, and the reflected light is detected as an optical signal (also referred to herein as a return signal, echo signal, or echo) by one or more of the detectors 110d (e.g., via receiver optics 112), converted into an electrical signal representation (referred to herein as a detection signal), and processed (e.g., based on time of flight) to define a 3-D point cloud representation 170 of the scene within the field of view 190. Operations of LIDAR systems in accordance with embodiments of the present invention as described herein may be performed by one or more processors or controllers, such as the control circuit 105 of FIG. 1.

In some embodiments, a receiver/detector module or circuit 110 includes an array of detector pixels (with each detector pixel including one or more detectors 110d, e.g., SPADs), receiver optics 112 (e.g., one or more lenses to collect light over the FoV 190), and receiver electronics (including timing circuit 106) that are configured to power, enable, and disable all or parts of the detector array 110 and to provide timing signals thereto. The detector pixels can be activated or deactivated with at least nanosecond precision, and may be individually addressable, addressable by group, and/or globally addressable.

The receiver optics 112 may include a macro lens that is configured to collect light from the largest FoV that can be imaged by the lidar system, a spectral filter to pass or allow passage of a sufficiently high portion of the ‘signal’ light (i.e., light of wavelengths corresponding to those of the optical signals output from the emitters) but substantially reject or prevent passage of non-signal light (i.e., light of wavelengths different than the optical signals output from the emitters), microlenses to improve the collection efficiency of the detecting pixels, and/or anti-reflective coating to reduce or prevent detection of stray light. For example, the receiver optics 112 may include an imaging filter that passes most or substantially all the arriving echo signal photons, yet rejects (a majority of) ambient photons.

The detectors 110d of the detector array 110 are connected to the timing circuit 106. The timing circuit 106 may be phase-locked to the driver circuitry 116 of the emitter array 115. The sensitivity of each of the detectors 110d or of groups of detectors may be controlled. For example, when the detector elements include reverse-biased photodiodes, avalanche photodiodes (APD), PIN diodes, and/or Geiger-mode Avalanche Diodes (SPADs), the reverse bias may be adjusted, whereby, the higher the overbias, the higher the sensitivity. The SPADs 110d of the detector array 110 may be discharged when the emitters 115e of the emitter array 115 fire, and may be (fully) recharged a short time after the emission of the optical pulse.

In some embodiments, at least one control circuit 105, such as a microcontroller or microprocessor, provides different emitter control signals to the driver circuitry 116 of different emitters 115e and/or provides different strobe signals to the timing circuitry 106 of different detectors 110d to vary the field of view of the lidar system 100 based on respective distance sub-ranges corresponding to respective strobe windows. Some embodiments described herein implement a time correlator, such that only pairs of (or more than two) avalanches detected within a pre-determined time are measured. In some embodiments, a measurement may include the addition of a fixed first charge (indicating a count value) onto a counting capacitor, as well as the addition of a second charge (which is a function of the arrival time) onto a time integrator. At the end of a frame, the control circuit(s) 105 may calculate the ratio of integrated time to number of arrivals, which is an estimate of the average time of arrival of photons for the detector pixel. The control circuit(s) 105 collect the point cloud data from the imager module (referred to herein as including the detector array 110 and accompanying processing circuitry), generating a 3D point cloud 170.

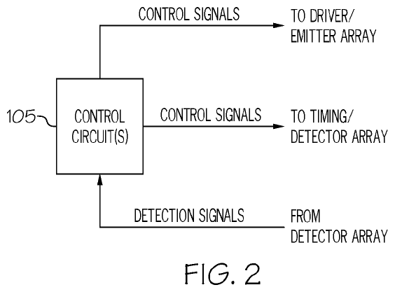

An example of a control circuit 105 that generates emitter and/or detector control signals is shown in FIG. 2. The control circuit of FIG. 2 may represent one or more control circuits, for example, an emitter control circuit that is configured to provide the emitter control signals to the driver circuitry 116 of the emitter array 115 and/or a detector control circuit that is configured to provide the strobe signals to the timing circuitry 106 of the detector array 110 as described herein. Also, the control circuit 105 may include a sequencer circuit that is configured to coordinate operation of the emitters 115e and detectors 110d. More generally, the control circuit 105 may include one or more circuits that are configured to generate the respective detector control signals that control the timing and/or durations of activation of subsets of the detectors 110d, and/or to generate respective emitter control signals that control the output of optical signals from subsets of the emitters 115e based on the distance sub-ranges corresponding to the respective strobe windows defined between the pulses of the optical signals from the emitters 115e. For example, the detector control signals output from the control circuit 105 may be provided to a variable delay line of the timing circuitry 106, which may generate and output the strobe signals with the appropriate timing delays to the detector array 110.

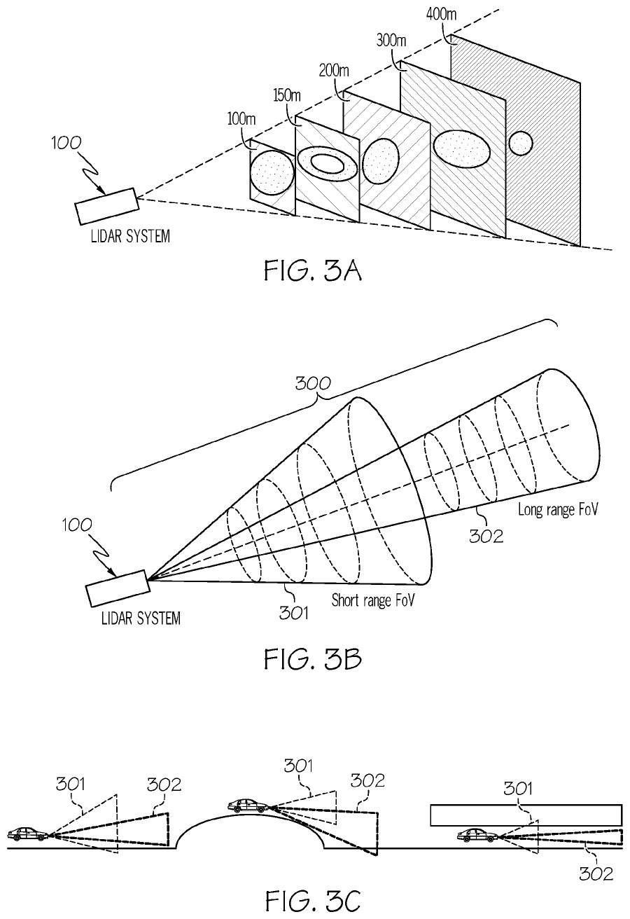

FIG. 3A illustrates dynamically varying the FoV of a lidar system 100 as a function of the distance sub-ranges being imaged in accordance with embodiments of the present invention. The rectangles illustrate cross-sections or ‘slices’ of the FoV corresponding to respective distance sub-ranges (e.g., 100±5 m, 150±5 m, 200±5 m 300±5 m, 400±5 m) imaged by the lidar system 100, and the ovals or elliptical shapes represent respective fields of view of the system in each range. The sequence of fields of view is collected in a single frame to form a 3D point cloud. One example is shown in FIG. 3B, where a FoV 300 of the lidar system 100 is relatively broad in one or more dimensions for a first portion 301 including a particular distance sub-range or set of distance sub-ranges (e.g., for shorter or closer distance ranges), and is relatively narrow in one or more dimensions for a second portion 302 including a distance sub-range or set of distance sub-ranges 302 (e.g., for longer or farther distance sub-ranges) relative to the lidar system 100. The fields of illumination of the emitter units and/or fields of detection of the detector pixels of the system FoV 300 may thus differ for the different distance sub-ranges.

Embodiments of the present invention may thus provide apparatus, systems, circuits, and methods of operation that can modify the field of view of a lidar system as a function of range. For example, a lidar system mounted in a car driving near a peak of a hill may set its field of view for downward portions of the forward range (i.e., negative vertical angles with respect to the horizon) to cover a longer distance range and may set its field of view for upward portions of the forward range (i.e., positive vertical angles with respect to the horizon) to cover a shorter distance range, while when the car is driving on a level road the lidar system may set its field of view for the forward range to be longer. FIG. 3C illustrates three scenarios for a car driving on a flat road (left), a car driving near the peak of a hill (middle), and a car driving in a tunnel (right), and how a lidar system (including portions of emitter and/or detector arrays) can be operated to provide different and dynamically varying configurations of short-range FoVs 301 and long range FoVs 302 for different distance subranges. Operating subsets of the emitters to reduce emission power in one or more directions (or to prevent full power emissions in all directions) can significantly reduce the power consumption of the lidar system. For example, embodiments described herein can be used to image into or inside a tunnel (e.g., with a narrower FoV in the forward direction) while reducing or avoiding detection of multipath reflections from the walls and the ceiling of the tunnel (and/or to similarly image within structures such a parking garages) by dynamically adapting the 3D FoV to the imaged surroundings.

As a specific example for a system with a 400 meter (m) imaging distance range, during the strobes spanning the first 200 m of the distance range, larger subsets of the emitter units may be operated to illuminate a greater portion or the full FoV, while during the strobes spanning the next 200 m of the distance range a selected smaller subset of the emitter units may be operated to illuminate a lesser portion of the FoV, based on use case. Similarly, larger and smaller subsets of the receivers/detector pixels may be likewise operated to detect greater and lesser portions of the FoV for shorter and farther subranges of the distance range, respectively. Emission power levels and/or detection sensitivity levels may also be varied based on the distance subrange being imaged. For example, as each detector pixel may include multiple photodetectors (e.g., SPADs), the number of photodetectors enabled per detector pixel can be programmed to vary (for example 1, 2 or 4 enabled photodetectors) on strobe by strobe basis and in conjunction with the FoV settings for the respective distance subranges.

As noted above, the field of view of the lidar system may include the intersection of the field of illumination of light or optical signals emitted from the emitters, the field of view over which light is detected by the receiver or detectors (also referred to as the field of detection), and the temporal detector strobe windows when or during which light is detected with reference to the emitted pulses of light.

A detector strobe window may refer to the respective durations of activation and deactivation of one or more detectors (e.g., responsive to respective strobe signals from a control circuit) over the temporal period or time between pulses of the emitter(s) (which may likewise be responsive to respective emitter control signals from a control circuit). The time between pulses (which defines a laser cycle, or more generally emitter pulse frequency) may be selected or may otherwise correspond to a desired imaging distance range for the lidar system. Each strobe window may be differently delayed relative to the emitter pulses, and thus may correspond to a respective portion or subrange of the distance range. Each strobe window may correspond to a respective image acquisition subframe (or more particularly, point cloud acquisition subframe, generally referred to herein as a subframe) of an image frame. A subframe may collect data responsive to multiple emitter pulses. For example there may be about 500, 1000, 2000 or 2500 laser cycles in each subframe. Each subframe may thus represent data collected for a corresponding distance sub-range over multiple laser cycles. A strobe window readout operation may be performed at the end of each subframe, with multiple subframes (each corresponding to a respective strobe window) making up each image frame (for example, 2, 5, 10, 15, 20, 25, 30 or 50 sub frames in each frame). That is, each image frame includes a plurality of subframes, each of the subframes samples or collects data for a respective strobe window over the temporal period, and each strobe window covers or corresponds to a respective distance subrange of the distance range. Range measurements and strobe window subrange correspondence as described herein are based on time of flight of an emitted pulse. Some strobing techniques (e.g., as described in United States Patent Application Publication No. 2017/0248796) may determine distance based on the strobe window during which an echo is received.

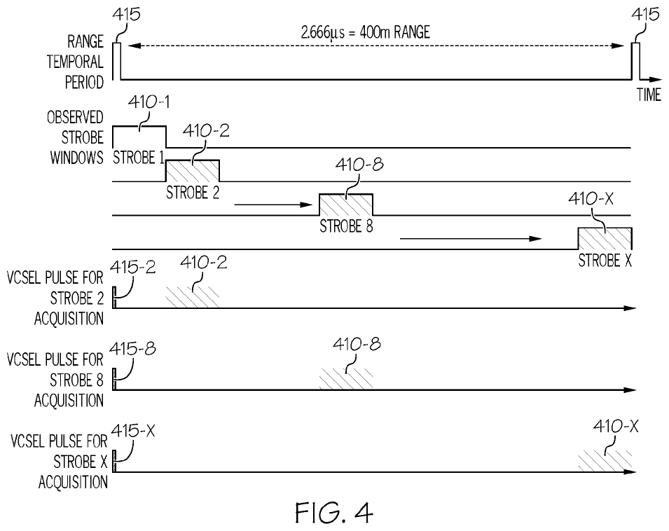

FIGS. 4 to 14 illustrate example strobe window timings and corresponding operations of an emitter array, a detector array, and related control circuitry to provide a field of view that varies as a function of the distance sub-ranges being imaged by the lidar system in accordance with some embodiments of the present invention. For example, the operations of FIGS. 4-14 may be performed by the control circuit 105, the timing circuit 106, the detector array 110, the driver circuit 116, and/or the emitter array 115 as described herein.

As noted above, the emitter pulse frequency of a lidar system may be selected or may otherwise correspond to the desired imaging distance range. For example, as shown in the timing diagram of FIG. 4, an emitter pulse frequency of about 375 kHz is selected to image a 400 m imaging distance range, with the 375 kHz frequency defining a temporal period of 2.666 microseconds (μs) between emitter pulses 415. In the example of FIG. 4, the emitter(s) 115e are implemented as VCSELs that are operated (e.g., responsive to control signals from one or more control circuits described herein) to emit pulsed optical signals at the beginning of each temporal period. The receiver/detectors 110d are operated (e.g., responsive to strobe signals from one or more control circuits described herein) so as to divide the 2.666 μs temporal period (and thus, the 400 m distance range) into X (e.g., 2 to 50) strobe windows 410-1 to 410-X, and to sequentially cycle through acquisitions (or more particularly, point-cloud acquisition subframes) for each of the strobe windows. The strobe window ranges can be mutually exclusive or overlapping in time, and/or can be monotonically increasing (e.g., in the order of the corresponding distance sub-ranges) or otherwise (e.g., to reduce or minimize heating).

In the example of FIG. 4, regardless or irrespective of which strobe window is being used for a particular acquisition, the VCSEL may be operated such that the output optical signals 415-1 to 415-X have the same power level, that is, the emission power may be uniformly applied to the emitter(s) for each strobe window. In particular, the VCSEL emission power may be the same for strobe window 2 (410-2) and 8 (410-8) and X (410-X), regardless of the respective sub-range of the 400 m distance covered by each strobe window. However, it will be understood that the emission power of the optical signals output from the emitter(s) may be varied for different strobe windows (e.g., decreased for closer strobe windows, increased for farther strobe windows) in some embodiments. Embodiments described herein may function in combination with such emitter power-stepping operations, as described for example in United States Patent Application Publication No. 2020/0249318 to Henderson et al., the disclosure of which is incorporated by reference herein.

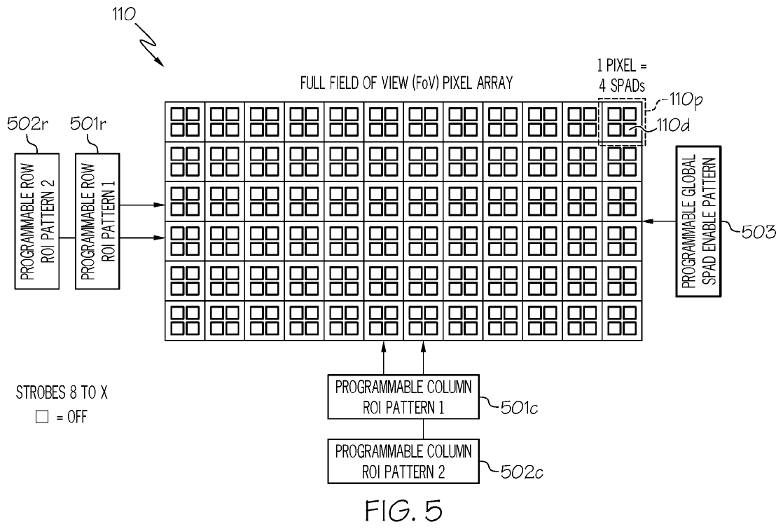

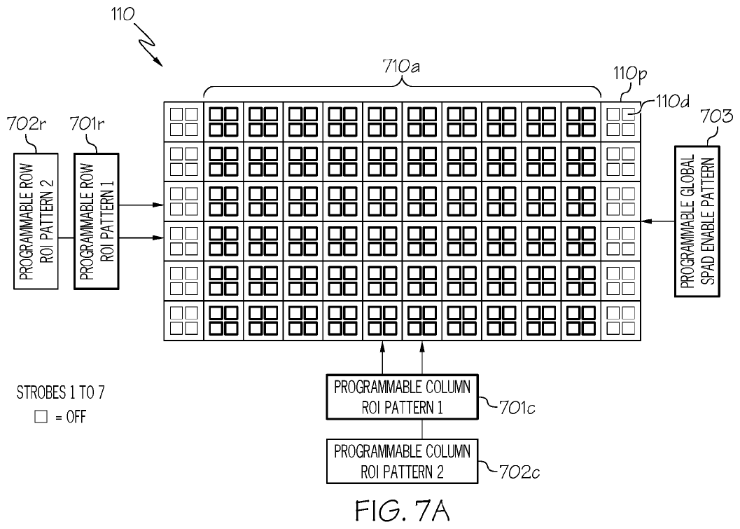

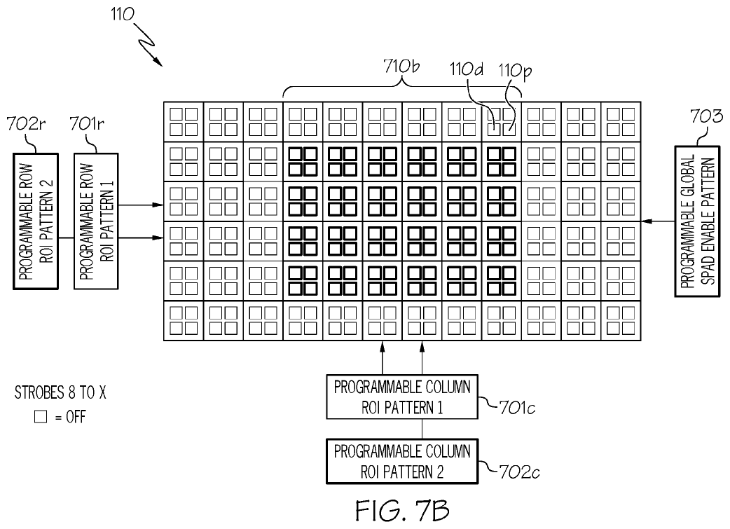

FIGS. 5, 7A-B, and 9A-C are block diagrams illustrating example operations of the detector array and control circuitry to provide varying FoVs for different distance sub-ranges corresponding to the strobe windows shown by the timing diagrams of FIGS. 4, 6, and 8, respectively. As shown in the examples of FIGS. 5, 7A-B, and 9A-C, each detector pixel 110p can include four detectors 110d (illustrated as SPADs by way of example). The detectors 110d of each pixel 110p may be individually activated or deactivated (e.g., to increase or decrease sensitivity of the detector pixels 110p) based on the expected signal level, in some embodiments in combination with adjusting the reverse bias of the SPADs 110d. As used herein, signal level or signal photons may refer to reflected light corresponding to the optical signals output from the emitters. The detector array and control circuitry are configured to be operated to provide multiple programmable banks of row and column region of interest (ROI) configurations or patterns 501r, 502r and 501c, 502c.

In FIG. 5, neither of the programmable banks of row 501r, 502r and column 501c, 502c ROI configurations is activated, such that all detector pixels of the detector array are enabled (e.g., in response to the global SPAD enable pattern 503) for the respective strobe windows 1 to X of FIG. 4. That is, in FIGS. 4 and 5, during each strobe window, the control circuitry is operated to provide a uniform FoV over the entire 400 m distance range, such that the receiver/detectors 110d are observing the full FoV and the emitters 115e are illuminating the full FoV. The range data from all X strobe windows is then combined to form one image acquisition frame.

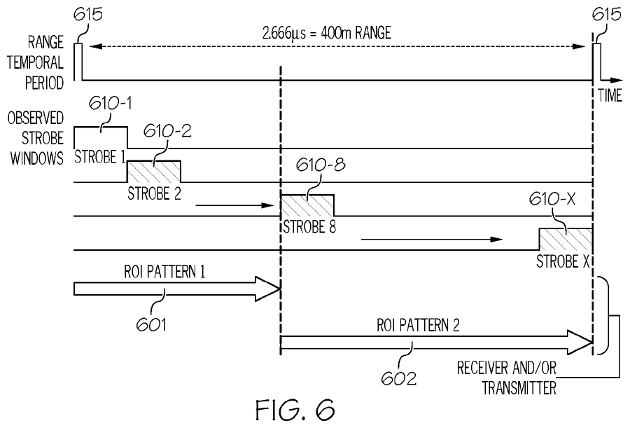

FIG. 6 is a timing diagram that illustrates operations to provide a field of view including varying ROI patterns over respective sub-ranges of the distance range. As shown in FIG. 6, an emitter pulse frequency of about 375 kHz defining a temporal period of 2.666 microseconds (μs) between emitter pulses 615 is selected to image a 400 m imaging distance range. The receiver/detectors 110d are operated (e.g., responsive to strobe signals from one or more control circuits) to divide the 2.666 μs temporal period into X (e.g., 2 to 50) strobe windows 610-1 to 610-X (each corresponding to a respective distance sub-range of the imaging distance range) and to sequentially cycle through acquisitions for the respective strobe windows. As noted above, each subframe may collect data for a respective strobe window 610-1 to 610-X over multiple laser cycles. For example, where X=30 strobe windows, the lidar system 100 may be operated to collect data for strobe window 610-1 (corresponding to a distance range of 0 to 10 m) over 1000 laser cycles, perform a strobe window readout operation, and then repeat this process for another strobe window (e.g., strobe window 610-2), until data has been collected for all 30 strobe windows to define a full image acquisition frame. It will be understood that acquisitions for the strobe windows 610-1 to 610-X need not be performed sequentially; e.g., in the example above where X=30 strobe windows, data may be collected for strobe window 610-1, then strobe window 610-7, then strobe window 610-12, etc., until data for all 30 strobe windows of the image frame have been acquired.

Still referring to FIG. 6, during a first subset of the strobe windows (e.g., for strobe windows 610-1 to 610-7), a first subset (710a in FIG. 7A) of the detectors 110d are operated to image a first ROI 601 (ROI pattern 1) of the FoV, while during a second subset of the strobe windows (e.g., for strobe windows 610-8 to 610-X), a second subset (710b in FIG. 7B) of the detectors 110d are operated to image a second ROI 602 (ROI pattern 2) of the FoV. In some embodiments, a first subset of the emitters 115e may likewise be operated for the first subset of the strobe windows to illuminate a first ROI 601 (ROI pattern 1), and a second subset of the emitters 115e may be operated for the second subset of the strobe windows to illuminate a second ROI 602 (ROI pattern 2). The range data collected during the X strobe windows 610-1 to 610-X (based on the different FoVs corresponding thereto) is then combined to form one image acquisition frame.

FIG. 7A illustrates example operation of the detector array 110 to provide ROI Pattern 1 601 of FIG. 6. As shown in FIG. 7A, a first programmable row ROI pattern 1 701r and a first programmable column ROI pattern 1 701c are applied to operate the subset 710a of the detector pixels 110p of the detector array 110 to image a relatively wide FoV for strobes windows 610-1 to 610-7, which may correspond to closer distance-subranges of the 400 m imaging distance range.

FIG. 7B illustrates example operation of the detector array 110 to provide ROI Pattern 2 602 of FIG. 6. In FIG. 7B, a second programmable row ROI pattern 2 702r and a second programmable column ROI pattern 2 702c are applied to operate the subset 710b of the detector pixels 110p of the detector array 110 to image a relatively narrower FoV for strobes 610-8 to 610-X, which may correspond to farther distance-subranges of the 400 m imaging distance range.

More generally, while two programmable ROI configurations are provided in the examples of FIGS. 6 to 7, the detectors (and/or emitters) may be operated to provide any number of ROI patterns. One of the ROI patterns (e.g., ROI pattern 1 or ROI pattern 2) may be selectively applied to operate the detector array 110 during any strobe window of operation (e.g., strobe window 610-1 to strobe window 610-X). In some embodiments, a first set of registers may be programmed to provide a first ROI pattern and a second set of registers may be programmed to provide a second, different ROI pattern simultaneously, in preparation for a subsequent strobe. Similarly, in embodiments where the detector pixels 110p include multiple SPADs 110d per pixel, a SPAD enable pattern 703 (e.g., for 4 SPADs per pixel) can be programmed on the fly/in real-time and applied during any strobe window of operation to activate different subsets of the detector(s) 110d of each detector pixel 110p. These ROI and SPAD controls allow the receiver/detector array 110 to adapt its FoV and reduce or optimize its power consumption on per strobe basis.

FIG. 8 is a timing diagram that illustrates operations to provide multiple ROI patterns 801, 802 over respective sub-ranges of the distance range in combination with operations to enable subsets of the detectors 110d in each detector pixel 110p. In particular, FIG. 8 illustrates a detector array FoV and SPAD enable example that provides two ROI patterns (ROI pattern 1 801 and ROI pattern 2 802), with ROI pattern 1 801 including a first stage 801a with respective strobe signals that activate a first subset of the SPADs 110d and a second stage 801b with respective strobe signals that activates a second subset of the SPADs 110d.

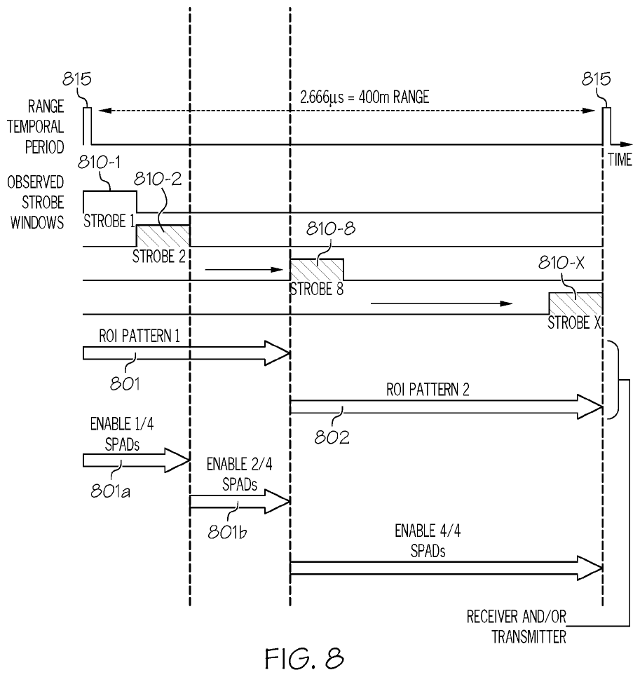

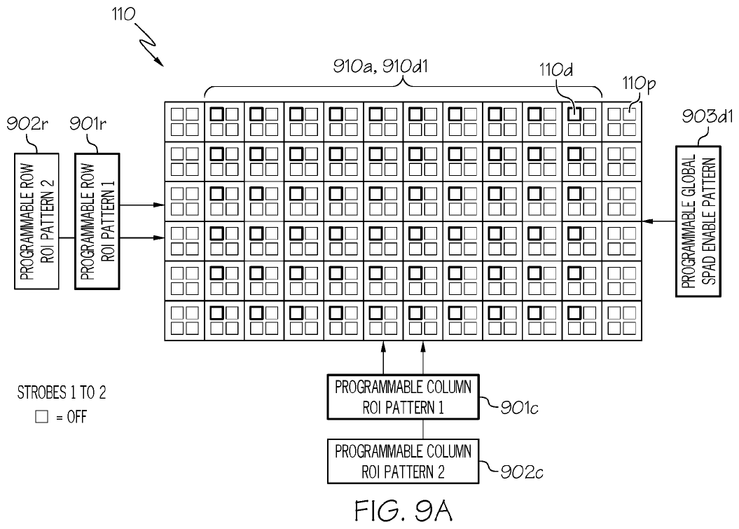

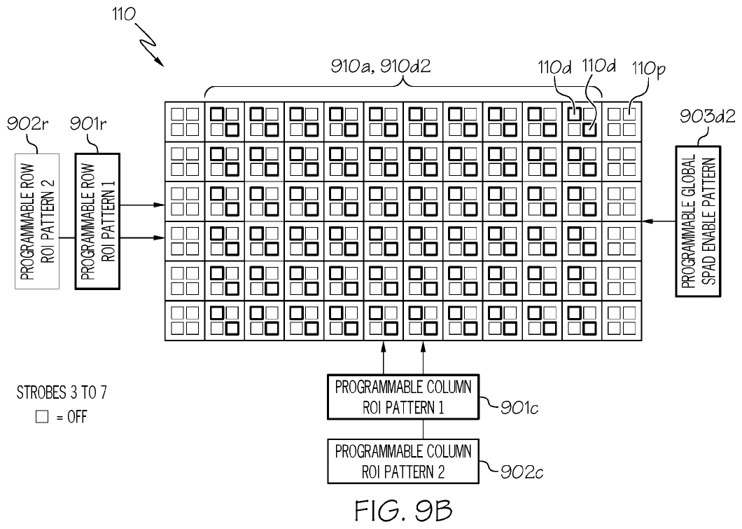

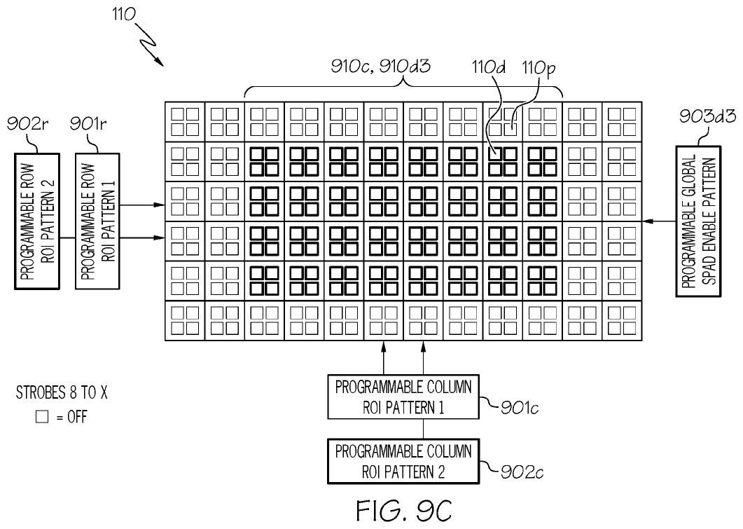

As shown in FIG. 8, during a first subset of the strobe windows (e.g., for strobe windows 810-1 to 810-7), a first subset (910a in FIGS. 9A and 9B) of the detectors 110d are operated to image a first ROI 801 (ROI pattern 1) of the FoV, while during a second subset of the strobe windows (e.g., for strobe windows 810-8 to 810-X), a second subset (910c in FIG. 9C) of the detectors 110d are operated to image a second ROI 802 (ROI pattern 2) of the FoV.

In some embodiments, a first subset of the emitters may likewise be operated for the first subset of the strobe windows to illuminate a first ROI 801, and a second subset of the emitters may be operated for the second subset of the strobe windows to illuminate a second ROI 802. In addition, for some strobe windows of the first subset of the strobe windows (e.g., for strobe windows 810-1 to 810-2), a first subset (910d1 in FIG. 9A) of the SPADs 110d may be activated (e.g., 1 out of the 4 SPADs per pixel 110p), and for other strobe windows of the first subset of the strobe windows (e.g., for strobe windows 801-3 to 801-7), a second subset (910d2 in FIG. 9B) of the SPADs 110d may be activated (e.g., 2 out of the 4 SPADs per pixel 110p). All 4 SPADs 110d per pixel 110p may be activated for the second subset of the strobe windows (e.g., for strobe windows 810-8 to 810-X) in this example, but it will be understood that different subsets of the SPADs 110d per pixel 110p may be likewise activated for different strobe windows of the second subset of the strobe windows. The range data collected during the X strobe windows is then combined to form one image acquisition frame.

FIG. 9A illustrates example operation of a detector array to provide the first stage 801a of ROI Pattern 1 801 of FIG. 8, including activation of the first subset 910d1 of the SPADs 110d. As shown in FIG. 9A, a first programmable row ROI pattern 1 901r and a first programmable column ROI pattern 1 901c are applied to operate the first subset 910a of the detector pixels 110p of the detector array 110 to image a relatively wide FoV for strobes windows 810-1 to 810-2. In addition, a first SPAD enable pattern 903d1 is applied to operate the individual pixels 110p of the detector array 110 to activate the subset 910d1 including one of the four SPADs 110d per detector pixel 110p. For example, as strobe windows 810-1 to 810-2 may correspond to the closest distance-subranges of the 400 m imaging distance range, and as the detector array 110 may accurately image closer distance sub-ranges even with lower detection sensitivity, activating only one SPAD 110d per detector pixel 110p for strobe windows 810-1 to 810-2 may allow for detector operation with reduced power consumption.

FIG. 9B illustrates example operation of a detector array to provide the second stage 801b of ROI Pattern 1 801 of FIG. 8, including activation of the second subset 910d2 of the SPADs 110d. As shown in FIG. 9B, the first programmable row ROI pattern 1901r and the first programmable column ROI pattern 1 901c are maintained to operate the first subset 910a of the detector pixels 110p of the detector array 110 to image a relatively wide FoV for strobes windows 810-3 to 810-7, while a second SPAD enable pattern 903d2 is applied to operate the individual pixels 110p of the detector array 110 to activate the subset 910d2 including two of the four SPADs 110d per detector pixel 110p. Activating two of the four SPADs 110d per detector pixel 110p may allow for increased detection sensitivity (relative to FIG. 9A) for accurately imaging the distance sub-ranges corresponding to strobe windows 810-3 to 810-7, but with reduced power consumption than if all four SPADs 110d per pixel 110p were activated.

FIG. 9C illustrates example operation of a detector array to provide ROI Pattern 2 802 of FIG. 8. As shown in FIG. 9C, a second programmable row ROI pattern 2 902r and a second programmable column ROI pattern 2 902c are applied to operate the detector array 110 to image a relatively narrow FoV for strobes windows 810-8 to 810-X. In addition, a global SPAD enable pattern 903d3 is applied to operate the individual pixels 110p of the second subset 910c of the detector pixels 110p of the detector array 110, and to activate the subset 910d3 including all four SPADs 110d per detector pixel 110p. For example, as strobe windows 810-8 to 810-X may correspond to the farthest distance-subranges of the 400 m imaging distance range, and as the detector array 110 may require higher detection sensitivity to accurately image farther distance sub-ranges, activating all four SPADs 110d per detector pixel 110p for only the strobe windows 810-8 to 810-X corresponding to the farther distance sub-ranges may allow for overall detector operation with reduced power consumption (as compared to activating all four detectors 110d per pixel 110p for all strobe windows 810-1 to 810-X).

While described above primarily with reference to addressing operations for detector arrays 110 to provide FoVs that vary with respective strobe windows/distance sub-ranges, embodiments of the present invention may include similar addressing operations for emitter arrays 115 to provide fields of illumination that vary with respective strobe windows/distance sub-ranges.

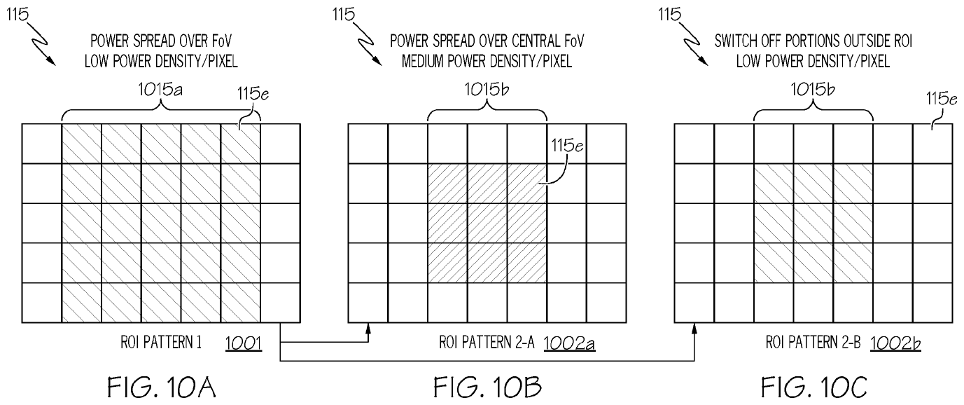

FIGS. 10A, 10B, and 10C are diagrams illustrating example operation of an emitter array 115 to provide illumination of the FoV with different ROI patterns 1001, 1002a, 1002b during strobe windows corresponding to different distance sub-ranges. The emitter array 115 is driven by an addressable driver circuit 116, which can control operation of the individual emitters 115e to perform operations including, but not limited to, activation of portions or sectors or regions of the emitter array 115 to illuminate particular ROIs (e.g., activating emitters 115e in central sectors or all sectors of the emitter array 115), control of the density of activation of the emitters 115e (e.g., activation of all VCSELs 115e in the array 115 for maximum power density, or every other VCSEL 115e for one half the power density), and/or control of the peak current driven to the emitters 115e at one or more optical emission power levels (e.g., the higher the non-zero peak current, the higher the optical emission power from each VCSEL 115e, up to a roll-over current level (which refers to the point beyond which optical emission power may decrease with further increases in drive current)).

For example, as similarly described above with reference to the detector array 110, the field of illumination and power density of the emitter array 115 can be changed or varied on a per strobe basis, allowing for control and redirection the available power towards the region of interest to increase system efficiency. In particular, as shown in FIG. 10A, the emitter array 115 may be operated to activate a subset 1015a of the emitters 115e (corresponding to the hatched regions of the emitter array 115 of FIG. 10A) to provide a ROI pattern 1 1001 that illuminates a relatively wide FoV with a lower power density per pixel (illustrated by the less dense hatching relative to FIG. 10B), while another subset of the emitters 115e (corresponding to the un-hatched regions at the edges of the array 115 of FIG. 10A) are not activated. For example, as the detector array 110 may accurately image closer distance sub-ranges even with lower detection sensitivity, the emitter array 115 may be operated to emit light with lower power output for strobe windows corresponding to closer distance sub-ranges of a 400 m imaging distance range.

As shown in FIG. 10B, the emitter array 115 may be operated to activate a subset 1015b of the emitters 115e (corresponding to the hatched regions of the emitter array 115 of FIG. 10B) to provide a different ROI pattern 2-A 1002a that illuminates a narrower, central portion of the FoV with a mid-level power density per pixel (illustrated by the more dense hatching relative to FIG. 10A), for example, to provide greater illumination for strobe windows corresponding to farther distance sub-ranges of a 400 m imaging distance range. Another subset of the emitters 115e (corresponding to the un-hatched regions at the peripheral portions of the array 115 of FIG. 10B) are not activated. This may provide lower power consumption than activating all of the emitters 115e of the array 115 for such farther distance sub-ranges, where a narrower FoV may be sufficient to provide accurate imaging. Alternatively, as shown in FIG. 10C, a subset of the emitters 115e that are outside or otherwise not positioned to illuminate the narrower FoV (corresponding to the un-hatched regions of the emitter array 115) can be switched off and the subset 1015b of the emitters 115e that are centrally located in the array 115 may be switched on to provide ROI pattern 2-B 1002b that illuminates the narrower, central portion of the FoV with the lower power density per pixel (illustrated by the less dense hatching relative to FIG. 10B), to further reduce power consumption.

In other words, the field of illumination of the emitter array 115 can be varied by providing a wider ROI pattern 1001 for strobe windows corresponding to first distance sub-ranges (e.g., for closer distances) and providing a narrower ROI pattern 1002a or 1002b for strobe windows corresponding to second distance sub-ranges (e.g., for farther distances) relative to the lidar system. The power output of the emitter array 115 can also be varied for the respective ROI patterns 1001, 1002a, 1002b, for example, by control of the peak current driven to the emitters 115e (e.g. with greater peak current to achieve the narrower ROI pattern 1002a as compared to the narrower ROI pattern 1002b) and/or by activation of a fewer or more emitters 115e in the array 115.

That is, as shown in the examples of FIGS. 10A-10C, emission per unit angle may be controlled by the power level of the peak drive current with which the emitter elements 115e arranged to illuminate that particular angle are driven, by (digitally) enabling only respective subsets 1015a, 1015b of the emitter elements 115e that are arranged in subregions of the emitter array 115 to illuminate that particular angle, or by a combination of both methods. It will be understood that, in some instances, only controlling or changing the drive current may not be sufficient to achieve a sufficient dynamic range (e.g., 1:900 in the case of 30 strobe gates) because at a sufficiently small current, emitter elements 115e implemented by VCSELs may enter a subthreshold region. It will also be understood that only activating a portion or subset of the emitter elements 115e may also not achieve the desired dynamic range (e.g., if there are fewer than 900 VCSELs per emitter element). Therefore, any combination of controlling the drive current and activating or enabling subsets of the emitters 115e may be used to vary the pattern and/or intensity of the field of illumination for respective distance sub-ranges.

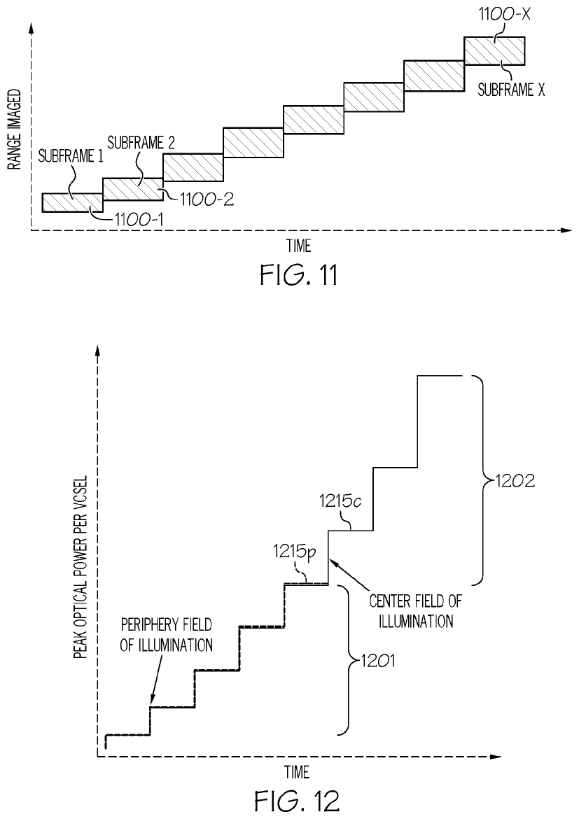

Further example operations of lidar systems to provide illumination and detection over FoVs with different ROI patterns are described below with reference to FIGS. 11-14.

FIG. 11 is a graph illustrating the timings of subframes in a full image acquisition frame (also referred to herein as a full frame or frame). As shown in FIG. 11, the full frame is divided into sequential subframes (1100-1 to 1100-X), each imaging a different distance sub-range of the imaging distance range. As noted above, each subframe may include data acquisition for multiple emitter pulses (e.g., 10 s, 100 s or 1000 s of laser pulses). The subframes 1100-1 to 1100-X may be equal or unequal in duration, and/or may be overlapping or non-overlapping with respect to the corresponding distance sub-ranges. For example, in some embodiments there may be an overlap in the distance sub-ranges imaged by consecutive subframes (e.g., Subframe 1 1100-1 may correspond to a distance sub-range of 0 m to 12 m, while Subframe 2 1100-2 may correspond to a distance sub-range of 10 m to 22 m). While illustrated as being acquired sequentially, it will be understood that the subframes 1100-1 to 1100-X may be acquired in any order (e.g., Subframe 1 1100-1 may be followed by Subframe X 1100-X and then Subframe 2 1100-2).

FIG. 12 is a graph illustrating that operating power and/or operating density of the emitters (illustrated with reference to VCSELs by way of non-limiting example) may be varied over the time or sub-frames of the frame. As shown in the graph of FIG. 12, the peak power of the light emitted from each VCSEL 115e (e.g., based on the applied current and/or the density of activated VCSELs 115e over the area of the emitter array 115) may be scaled such that the optical power output of the emitter array 115 (and/or portions thereof) is varied or optimized for each distance sub-range. For example, as shown in FIG. 12, a respective VCSEL 115e may be operated to provide varying levels of lower-power emission 1201 for subframes that image closer distance sub-ranges, and with increasing power to provide varying levels of higher-power emission 1202 for subframes that image farther distance sub-ranges. More particularly, FIG. 12 illustrates that a first subset 1215p of VCSELs 115e that are arranged in the array 115 to provide a peripheral field of illumination are operated to provide the lower power emission 1201 for the subframes that image closer distance sub-ranges, but are turned off or deactivated for the subframes that image farther distance sub-ranges. A second subset 1215c of VCSELs 115e that are arranged in the array 115 to provide a central field of illumination are operated to provide the lower power emission 1201 for the subframes that image closer distance sub-ranges, and are operated to provide the higher power emission 1202 for the subframes that image farther distance sub-ranges.

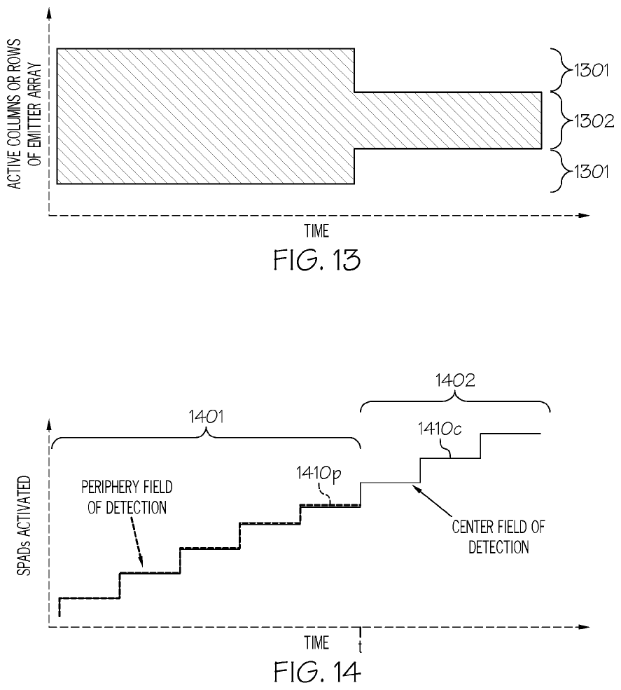

Also, as noted above with reference to FIGS. 10A-10C, subsets of the emitters 115e of the emitter array 115 may be deactivated (or operated at reduced power levels) to image particular strobe windows (e.g., for strobe windows corresponding to distance sub-ranges where a narrower ROI is desired, emitters arranged to illuminate central portions of the ROI may be operated with higher emission power than emitters arranged to illuminate peripheral portions of the ROI), thereby creating a 2-dimensional field of illumination as a function of time in the frame. FIG. 13 is a graph illustrating an example where a subset 1302 of emitters 115e arranged at central portions of the emitter array 115 are operated to illuminate all of the distance sub-ranges (e.g., from 0 to 400 m, with increasing power for farther distance sub-ranges) over the time of the full frame to provide a narrow, central field of illumination, while a subset 1301 of emitters 115e arranged at peripheral portions of the array 115 illuminate a subset of the distance sub-ranges (e.g., from 0 to 200 m, with medium or lower power for closer distance sub-ranges) for a subset of the full frame to provide a wider, peripheral field of illumination. That is, the subset 1302 including the centrally-arranged emitters 115e are activated to emit light for all of the strobe gates corresponding to the 400 m distance range, to provide lower power emission for the strobe gates corresponding to 0 to 200 m, and to provide higher power emission for the strobe gates corresponding to 200 to 400 m.

FIG. 14 is a graph illustrating operation of detectors (illustrated with reference to SPADs by way of non-limiting example) over the time of the full frame. As shown in FIG. 14, one or more SPADs 110d of a SPAD array 110 can be activated at different delays from the laser pulses, with the different delays corresponding to the respective distance sub-ranges (and associated subframes and strobe windows) of the imaging distance range. Each strobe window corresponds to one or more laser cycles. More particularly, FIG. 14 illustrates that a first subset 1410p of SPADs 110d (or detector pixels 110p) that are positioned in the array 110 to provide a peripheral field of detection are operated for a first subset 1401 of subframes that image closer distance sub-ranges, but are turned off or deactivated for the subframes that image farther distance sub-ranges. A second subset 1410c of SPADs 110d (or detector pixels 110p) that are positioned in the array 110 to provide a central field of detection are operated for both the first subset 1401 of the subframes that image closer distance sub-ranges, and for a second subset 1402 of the subframes that image farther distance sub-ranges.

The durations of activation of the SPADs 110d may be equal or unequal. Also, the density of activated SPADs 110d may be scaled such that a sensitivity of the detector array 110 (and/or portions thereof) is varied or optimized for each distance sub-range, e.g., by activating subsets of the SPADs 110d. For example, as noted above with reference to FIGS. 8 and 9A-C, fewer SPADs 110d per detector pixel 110p may be activated for subframes that image closer distance sub-ranges, and more SPADs 110d per detector pixel 110p may be activated for subframes that image farther distance sub-ranges. Also, for strobe windows corresponding to distance sub-ranges where a narrower ROI is desired, detector pixels 110p arranged to image central portions of the ROI may be operated with greater detection sensitivity (e.g., by activating more SPADs 110d per detector pixel 110p) than detector pixels 110p arranged to image peripheral portions of the ROI.

It will be understood that emitters and/or detectors that are configured to operate according to the examples described herein operate based on respective control signals (such as emitter control signals and detector strobe signals) generated by one or more associated control circuits, such as a sequencer circuit that may coordinate operation of the emitter array and detector array. That is, the respective control signals may be configured to control temporal and/or spatial operation of individual emitter elements of the emitter array and/or individual detector elements of the detector array to provide functionality as described herein.

Embodiments of the present invention may be used in conjunction with operations for varying the number or rate of readouts based on detection thresholds, as described for example in U.S. patent application Ser. No. 16/733,463 entitled “High Dynamic Range Direct Time of Flight Sensor with Signal-Dependent Effective Readout Rate” filed Jan. 3, 2020, the disclosure of which is incorporated by reference herein. For example, a power level of the emitter signals may be reduced in response to one or more readouts that are based on fewer cycles of the emitter signals (indicating a closer and/or more reflective target), or the power level of the emitter signals may be increased in response to one or more readouts that are based on more cycles of the emitter signals (indicating farther and/or less reflective targets).

Likewise, a smaller subset of the detector elements or detector pixels may be activated (e.g., in response to respective strobe signals) in response to one or more readouts that are based on fewer cycles of the emitter signal (indicating a closer and/or more reflective target), or a larger subset of the detector elements or detector pixels may be activated in response to one or more readouts that are based on more cycles of the emitter signal (indicating farther and/or less reflective targets).

Lidar systems and arrays described herein may be applied to ADAS (Advanced Driver Assistance Systems), autonomous vehicles, UAVs (unmanned aerial vehicles), industrial automation, robotics, biometrics, modeling, augmented and virtual reality, 3D mapping, and security. In some embodiments, the emitter elements of the emitter array may be VCSELs. In some embodiments, the emitter array may include a non-native (e.g., curved or flexible) substrate having thousands of discrete emitter elements electrically connected in series and/or parallel thereon, with the driver circuit implemented by driver transistors integrated on the non-native substrate adjacent respective rows and/or columns of the emitter array, as described for example in U.S. Patent Application Publication No. 2018/0301872 to Burroughs et al., the disclosure of which is incorporated by reference herein.

Various embodiments have been described herein with reference to the accompanying drawings in which example embodiments are shown. These embodiments may, however, be embodied in different forms and should not be construed as limited to the embodiments set forth herein. Rather, these embodiments are provided so that this disclosure is thorough and complete and fully conveys the inventive concept to those skilled in the art. Various modifications to the example embodiments and the generic principles and features described herein will be readily apparent. In the drawings, the sizes and relative sizes of layers and regions are not shown to scale, and in some instances may be exaggerated for clarity.

The example embodiments are mainly described in terms of particular methods and devices provided in particular implementations. However, the methods and devices may operate effectively in other implementations. Phrases such as “example embodiment”, “one embodiment” and “another embodiment” may refer to the same or different embodiments as well as to multiple embodiments. The embodiments will be described with respect to systems and/or devices having certain components. However, the systems and/or devices may include fewer or additional components than those shown, and variations in the arrangement and type of the components may be made without departing from the scope of the inventive concepts.

The example embodiments will also be described in the context of particular methods having certain steps or operations. However, the methods and devices may operate effectively for other methods having different and/or additional steps/operations and steps/operations in different orders that are not inconsistent with the example embodiments. Thus, the present inventive concepts are not intended to be limited to the embodiments shown, but are to be accorded the widest scope consistent with the principles and features described herein.

It will be understood that when an element is referred to or illustrated as being “on,” “connected,” or “coupled” to another element, it can be directly on, connected, or coupled to the other element, or intervening elements may be present. In contrast, when an element is referred to as being “directly on,” “directly connected,” or “directly coupled” to another element, there are no intervening elements present.

It will also be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

It will also be understood that the term “and/or” as used herein refers to and encompasses any and all possible combinations of one or more of the associated listed items. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, the regions illustrated in the figures are schematic in nature and their shapes are not intended to illustrate the actual shape of a region of a device and are not intended to limit the scope of the invention.

Unless otherwise defined, all terms used in disclosing embodiments of the invention, including technical and scientific terms, have the same meaning as commonly understood by one of ordinary skill in the art to which this invention belongs, and are not necessarily limited to the specific definitions known at the time of the present invention being described. Accordingly, these terms can include equivalent terms that are created after such time. It will be further understood that terms, such as those defined in commonly used dictionaries, should be interpreted as having a meaning that is consistent with their meaning in the present specification and in the context of the relevant art and will not be interpreted in an idealized or overly formal sense unless expressly so defined herein. All publications, patent applications, patents, and other references mentioned herein are incorporated by reference in their entireties.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments of the present invention described herein, and of the manner and process of making and using them, and shall support claims to any such combination or subcombination.

Although the invention has been described herein with reference to various embodiments, it will be appreciated that further variations and modifications may be made within the scope and spirit of the principles of the invention. Although specific terms are employed, they are used in a generic and descriptive sense only and not for purposes of limitation, the scope of the present invention being set forth in the following claims.

1. A Light Detection and Ranging (LIDAR) system, comprising:
an emitter array comprising a plurality of emitter units operable to emit optical signals;
a detector array comprising a plurality of detector pixels operable to detect light for respective strobe windows between pulses of the optical signals; and
one or more control circuits configured to selectively operate different subsets of the emitter units and/or different subsets of the detector pixels such that a field of illumination of the emitter units and/or a field of view of the detector pixels is varied based on the respective strobe windows.

2. The LIDAR system of claim 1, wherein the respective strobe windows comprise first and second strobe windows corresponding to different first and second sub-ranges of a distance range, respectively, and wherein the one or more control circuits comprises:
an emitter control circuit configured to operate a first subset of the emitter units to provide a first field of illumination during the first strobe window, and to operate a second subset of the emitter units to provide a second field of illumination, different than the first field of illumination, during the second strobe window; and/or
a detector control circuit configured to operate a first subset of the detector pixels to provide a first field of view during the first strobe window, and to operate a second subset of the detector pixels to provide a second field of view, different than the first field of view, during the second strobe window.

3. The LIDAR system of claim 2, wherein the detector control circuit is configured to operate the second subset of the detector pixels with a greater detection sensitivity level than the first subset of the detector pixels.

4. The LIDAR system of claim 3, wherein each of the detector pixels comprises a plurality of detectors, and wherein the detector control circuit is configured to generate respective strobe signals that activate a first subset of the detectors for the first strobe window, and activate a second subset of the detectors, larger than the first subset of the detectors, for the second strobe window.

5. The LIDAR system of claim 2, wherein the second field of illumination comprises a greater emission power level than the first field of illumination.

6. The LIDAR system of claim 5, wherein the emitter control circuit is configured to generate respective emitter control signals comprising a first non-zero peak current to activate the first subset of the emitters for the first strobe window, and comprising a second peak current, greater than the first non-zero peak current, to activate the second subset of the emitters for the second strobe window.

7. The LIDAR system of claim 2, wherein:
the first strobe window corresponds to closer distance sub-ranges of the distance range than the second strobe window; and
the first field of illumination and/or the first field of view is wider than the second field of illumination and/or the second field of view.

8. The LIDAR system of claim 7, wherein the first subset of the emitter units comprises one or more of the emitter units that are positioned at a peripheral region of the emitter array, and the second subset of the emitter units comprises one or more of the emitter units that are positioned at a central region of the emitter array.

9. The LIDAR system of claim 8, wherein the first subset of the emitter units comprises a first string of the emitter units electrically connected in series, and wherein the second subset of the emitter units comprises a second string of the emitter units electrically connected in series.

10. The LIDAR system of claim 7, wherein the first subset of the detector pixels comprises one or more of the detector pixels that are positioned at a peripheral region of the detector array, and the second subset of the detector pixels comprises one or more of the detector pixels that are positioned at a central region of the detector array.

11. The LIDAR system of claim 1, wherein the emitter array comprises the emitter units on a curved and/or flexible substrate, and wherein the different subsets of the emitter units are operable to provide the field of illumination without one or more lens elements.

12. The LIDAR system of claim 1, wherein the respective strobe windows correspond to respective acquisition subframes of the detector pixels, wherein each acquisition subframe comprises data collected for a respective distance sub-range of a distance range, and wherein an image frame comprises the respective acquisition subframes for each of the distance sub-ranges of the distance range.

13. The LIDAR system of claim 12, wherein:
the image frame is a current image frame; and
the one or more control circuits is configured to provide the field of illumination of the emitter units and/or the field of view of the detector pixels that varies for the respective sub-ranges of the distance range in the current image frame based on one or more features of the field of view indicated by detection signals received from the detector pixels in a preceding image frame before the current image frame.

14. The LIDAR system of claim 13, wherein, in the preceding image frame, the one or more control circuits are configured to provide the field of illumination of the emitter units and/or the field of view of the detector pixels that is static for the respective sub-ranges of the distance range.

15. A Light Detection and Ranging (LIDAR) system, comprising:
at least one control circuit configured to output respective emitter control signals to operate emitter units of an emitter array and/or respective strobe signals to operate detector pixels of a detector array such that a field of illumination of the emitter units and/or a field of view of the detector pixels varies for respective sub-ranges of a distance range imaged by the LIDAR system.

16. The LIDAR system of claim 15, wherein the detector pixels are operable to detect light for respective strobe windows between pulses of the optical signals responsive to the respective strobe signals, wherein the respective strobe windows correspond to the respective sub-ranges of the distance range.

17. The LIDAR system of claim 16, wherein the respective strobe windows comprise first and second strobe windows, and wherein the respective strobe signals operate a first subset of the detector pixels to detect the light over a first field of view during the first strobe window, and operate a second subset of the detector pixels to detect light over a second field of view, different than the first field of view, during the second strobe window.

18. The LIDAR system of claim 17, wherein the respective strobe signals operate the second subset of the detector pixels with a greater detection sensitivity level than the first subset of the detector pixels.

19. The LIDAR system of claim 18, wherein each of the detector pixels comprises a plurality of detectors, and wherein the respective strobe signals activate a first subset of the detectors for the first strobe window, and activate a second subset of the detectors, larger than the first subset of the detectors, for the second strobe window.

20. The LIDAR system of claim 16, wherein the respective strobe windows comprise first and second strobe windows, and wherein the respective emitter control signals operate a first subset of the emitter units to provide a first field of illumination during the first strobe window, and operate a second subset of the emitter units to provide a second field of illumination, different than the first field of illumination, during the second strobe window.

21. The LIDAR system of claim 20, wherein the second field of illumination comprises a greater emission power level than the first field of illumination.

22. The LIDAR system of claim 21, wherein the respective emitter control signals comprise a first non-zero peak current to activate the first subset of the emitters for the first strobe window, and comprise a second peak current, greater than the first non-zero peak current, to activate the second subset of the emitters for the second strobe window.

23. A method of operating a Light Detection and Ranging (LIDAR) system, the method comprising:
generating respective emitter control signals to operate different subsets of emitter units of an emitter array to emit optical signals and/or generating respective strobe signals to operate different subsets of detector pixels of a detector array to detect light, such that a field of illumination of the emitter units and/or a field of view of the detector pixels varies for respective sub-ranges of a distance range imaged by the LIDAR system.

24. The method of claim 23, wherein the detector pixels are operable to detect light for respective strobe windows between pulses of the optical signals responsive to the respective strobe signals, wherein the respective strobe windows comprise first and second strobe windows corresponding to different first and second sub-ranges of the distance range, respectively, and wherein:
the respective emitter control signals operate a first subset of the emitter units to provide a first field of illumination during the first strobe window, and operate a second subset of the emitter units to provide a second field of illumination, different than the first field of illumination, during the second strobe window; and/or
the respective strobe signals operate a first subset of the detector pixels to provide a first field of view during the first strobe window, and operate a second subset of the detector pixels to provide a second field of view, different than the first field of view, during the second strobe window.

25. The method of claim 24, wherein the respective strobe signals operate the second subset of the detector pixels during the second strobe window with a greater detection sensitivity level than the first subset of the detector pixels during the first strobe window.

26. The method of claim 24, wherein the respective emitter control signals operate the second subset of the emitter units during the second strobe window with a greater power level than the first subset of the emitter units during the first strobe window.

27. (canceled)
